(19) United States
(12) Patent Application Publication
(10) Pub. No.: US 2012/0226532 A1
(43) Pub. Date: Sep. 6, 2012

(54) MITIGATION OF CONGESTION IN USE OF A CAPACITY CONSTRAINED RESOURCE BY PROVIDING INCENTIVES

(76) Inventors: Balaji S. Prabhakar, Palo Alto, CA (US); Deepak Merugu, Stanford, CA (US); Naini R. Gomes, Stanford, CA (US)

(21) Appl. No.: 13/410,155

(22) Filed: Mar. 1, 2012

Related U.S. Application Data
(60) Provisional application No. 61/448,169, filed on Mar. 1, 2011.

(51) Int. Cl. G06Q 30/02; G06F 15/16

(52) U.S. Cl. 705/14.14

(57) ABSTRACT

Congestion of a network being accessed by users is mitigated by providing predetermined incentive credits to users who follow network use recommendations and allowing the users to redeem accumulated credits for entry in a game of chance that provides a chance of winning a large reward. A server collects network use data to determine network congestion states and to determine whether users followed network use recommendations. The server also implements a web portal through which users can view historical network use and awarded credits, and redeem their credits. Application domains of the method to mitigate congestion include public transportation networks, wireless communication networks, and energy distribution networks. The techniques may also be enhanced by integration with online social networking features.

### CROSS-REFERENCE TO RELATED APPLICATIONS

This application claims priority from U.S. Provisional Patent Application 61/448,169 filed Mar. 1, 2011, which is incorporated herein by reference.

### FIELD OF THE INVENTION

The present invention relates generally to methods and systems for managing use of a capacity-constrained resource. More specifically, it relates to methods for mitigating traffic congestion caused by excess demand for access to, or use of, a limited resource.

### BACKGROUND OF THE INVENTION

Infrastructures such as public transportation networks, wireless communication networks, and energy distribution networks share the common feature that they have a limited capacity and can become congested if too many users attempt to use the network resource. Typically, the widespread approach to managing a scarce resource is to increase the charge to users for access during peak or congested periods. This approach, however, has several disadvantages. For example, charging for access during highly desirable periods gives preferential access to wealthy users. Charging extra fees for access also fosters a negative attitude toward network use, which can be detrimental to network operator businesses that want to encourage network use and a positive attitude toward use. There is thus a need for new approaches to managing congestion that avoid these and other disadvantages of the conventional approaches to congestion management.

### SUMMARY OF THE INVENTION

In one aspect, the present invention includes methods for mitigating congestion of a network being accessed by users. The methods may be implemented in a system comprising a capacity-constrained network, users accessing the network and its limited resource, and a server connected to the network and to the users. The methods reduce network use congestion by providing predetermined credits to users who follow customized network use recommendations and allowing the users to redeem their credits for entry in a raffle or lottery that provides a chance of winning a large reward.

Embodiments of the method include determining by a server a congestion state of the network; identifying by the server users of the network contributing to the congestion state; computing by the server, for each of the users, a network use recommendation based on the congestion state of the network, and a current or historical network use of the user; sending from the server to the user an incentive offer to award the user a credit if the user follows the network use recommendation, whereby the user is given an incentive to use the network efficiently to mitigate congestion; awarding by the server the credit to the user if a measured network use of the user confirms that the user followed the network use recommendation; storing by the server accumulated awarded credits for the user over time; randomly selecting by the server a winner from among users awarded credits for following network use recommendations; and transferring rewards to the randomly selected winner.

In some embodiments, the congestion state determined by the server may be a present congestion state of the network (e.g., determined in real-time from network measurements). Moreover, in addition to determining the network state in real time, the server may also identify users contributing to the congestion in real time, compute the network use recommendations in real time, and send the incentive offers to the users in real time.

In some embodiments, the server determines a future congestion state of the network (e.g., predicted from historical network state measurements). Moreover, the server may identify users contributing to the congestion at a future time (e.g., predicted from historical user data), computes the network use recommendations offline, and sends the offers to the users offline (e.g., in advance of a predicted congestion state of the network).

The network use recommendation may be a recommendation to use the network during a specified time, a recommendation to use the network at a specified network location, or a recommendation to engage in a specified type of use of the network. (e.g., mode of transport, public transport, carpooling, lower bandwidth mode, voice only)

Significantly, the users who follow the network use recommendation are guaranteed to be awarded credits as specified in the offer sent to them by the server, and the users may accumulate these awarded credits over time. The method may also include sending to the users of the network information including cumulative awarded credits earned and historical network use data.

In addition, the users are provided with the opportunity to redeem these accumulated credits in a raffle or lottery in which the user has a random chance of being selected as a winner of a reward. In some embodiments, the random selection of a winner in the raffle or lottery and associated transferring of rewards are performed periodically. In some embodiments, the randomly selecting by the server selects multiple winners from among users awarded credits for following network use recommendations and is performed at periodic scheduled intervals (e.g., once a week). In other embodiments, the server receives from the users of the network requests to redeem awarded credits for entry in a game of chance, and the randomly selecting by the server is performed immediately in response to a request by one of the users. In some embodiments, the server also may receive from the users of the network requests to redeem awarded credits for cash rewards; and the server awards the cash rewards to the users in response to the requests.

In some embodiments of the invention, the selection of a winner is performed such that a user who has accumulated more credits has a greater chance of being selected a winner than a user who has accumulated fewer credits. Moreover, a user awarded more credits may be given a greater chance of being selected for a larger reward than a user awarded fewer credits. (e.g., in a pyramid structure having multiple levels where higher levels have larger minimum credit eligibility requirements, fewer winners, and larger rewards than lower levels.)

The methods of the present invention may be implemented by a server to implement congestion mitigation for various types of networks involving use of a capacity constrained resource. For example, the network may be a public transportation network and the congestion is vehicle traffic congestion in the public transportation network. Alternatively, the network may be a wireless communications network and the congestion is wireless traffic congestion in the wireless communications network. In another case, the network may be an energy distribution network and the congestion is excessive energy demand in the energy distribution network. These capacity-constrained networks all suffer from the problem of congestion when too many users access the network at the same time, in the same location, and/or in the same manner. Accordingly, the techniques of the present invention may be applied to these different types of networks.

For example, where the network may be a public transportation network and the congestion is vehicle traffic congestion in the public transportation network, the server may determine a congestion state of the network by estimating a congestion state based on historical network congestion data. (e.g., trip time data). In addition, the congestion state of the network may be estimated based on real-time network congestion data measurements. (e.g., real-time GPS traces sent to server). This congestion state may include measures such as a mobility heat map, bottle-necks, and traffic jams.

The server may identify users of the network contributing to the congestion state by predicting user network use based on historical user network use data, or by predicting user network use based on real-time user network use data. (e.g., GPS traces) The method may include measuring GPS tracks of the user to determine the measured network use of the user, and the network use recommendation may be a real-time or offline (advance) recommendation to follow a specified route at a specified time.

In the case where the network is a wireless communications network and the congestion is wireless traffic congestion in the wireless communications network, the server may determine a congestion state of the network by measuring a current communication load of a cellular base station or network data hub. Users of the network contributing to the congestion state may be identified by identifying cellular handsets connected to the network through a congested base station, or identifying users who are likely to access the network during a predicted congestion state. Sending to the user an offer to award the user a credit if the user follows the network use recommendation may include sending the user an offer to award the user a credit for using the network during a specified time or using an alternative mode of access. For example, the technique may include displaying to the user an indication that a base station cell is currently congested and an offer to award the user a credit for using the network from a non-congested base station cell.

In the case where the network is an energy distribution network and the congestion is excessive energy demand in the energy distribution network, the users of the network contributing to the congestion state may be identified by identifying utility customer smart energy meter readings higher than a predetermined benchmark. Users may then be offered credits for following a recommendation to decrease their energy consumption during a specified time (e.g., peak energy use).

In another application, the invention provides a method for incentivizing wellness by implementing an online social network, identifying by the server users of the social network who are enrolled in a wellness incentive program, computing by the server, for each of the users, a recommendation to engage in activity that will increase wellness and health, sending from the server to the user an offer to award the user a credit if the user follows the recommendation to engage in activity that will increase wellness and health, awarding by the server the credit to the user if a measured activity of the user confirms that the user followed the recommendation to engage in activity that will increase wellness and health, storing by the server accumulated awarded credits for the user over time, providing by the server a user interface visible on the social network for viewing accumulated awarded credits and associated historical activity of the user, randomly selecting by the server a winner from among users awarded credits for following network use recommendations, and transferring rewards to the randomly selected winner.

### BRIEF DESCRIPTION OF THE DRAWINGS

FIG. 1 is a block diagram of a system implementing a method for congestion mitigation of a network, according to an embodiment of the invention.

FIG. 2 is a flow chart outlining steps of a method for congestion mitigation of a network, according to an embodiment of the invention.

FIG. 3 is a schematic diagram showing random selection of winners from among users awarded credits in a reward redemption scheme, according to an embodiment of the present invention.

FIG. 4 is a diagram illustrating a multi-level pyramid reward structure of a credit redemption scheme, according to an embodiment of the invention.

FIG. 5 is a diagram of a web portal user interface generated by the server for displaying to a user historical network use information and providing access to credit redemption options, according to an embodiment of the invention.

FIG. 6 is a flow chart illustrating an application of methods of the invention to vehicle traffic congestion mitigation in a transportation network.

FIG. 7 is a schematic diagram of a system in which a method of vehicle traffic mitigation may be implemented according to an embodiment of the present invention.

FIG. 8 is a flowchart illustrating an offline recommendation process according to an embodiment of the present invention.

FIG. 9 is a schematic diagram of a system in which a method of wireless network traffic mitigation may be implemented according to an embodiment of the present invention.

FIG. 10 is a schematic diagram of a system in which a method of mitigating congestion in an energy distribution network may be implemented according to an embodiment of the present invention.

### DETAILED DESCRIPTION

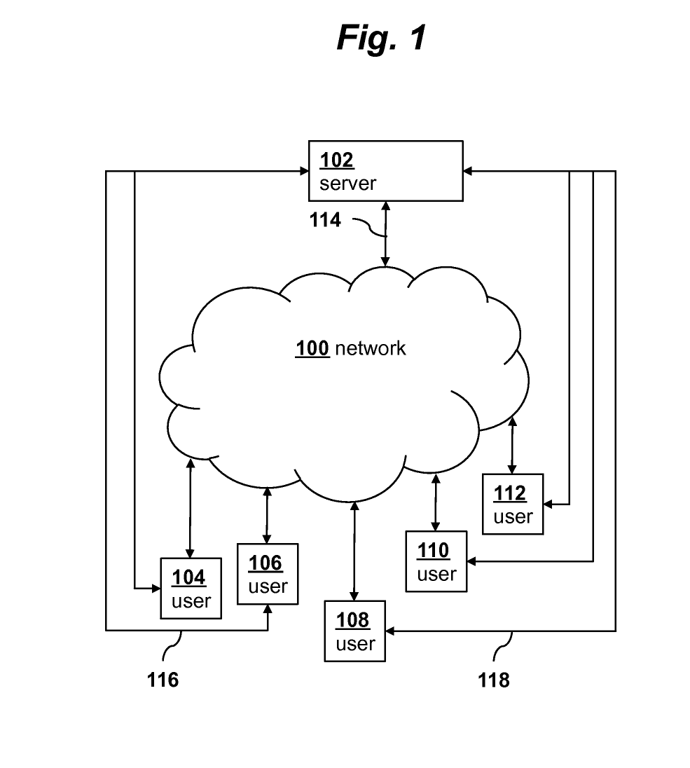

Embodiments of the present invention may be implemented in a system a shown schematically in FIG. 1. The system includes a capacity-constrained network 100 such as a transportation network, a wireless communications network, or an energy distribution network. A collection of users, such as users 104, 106, 108, 110, 112 access the network and its limited resource, e.g., through the use of vehicles, wireless devices, or home appliances. These capacity-constrained networks are characterized by problems of congestion when too many users access the network at the same time, same place, or in the same way. Accordingly, a server 102 connected to the network 100 and to the users 104, 106, 108, 110, 112 implements methods for mitigating congestion of the network being accessed by users. The methods reduce network use congestion by awarding specified incentive credits to those users who follow personalized network use recommendations. The users may accumulate these credits over time and redeem the accumulated credits for entry in a raffle or lottery that provides a chance of winning a large reward, as will be described in more detail below.

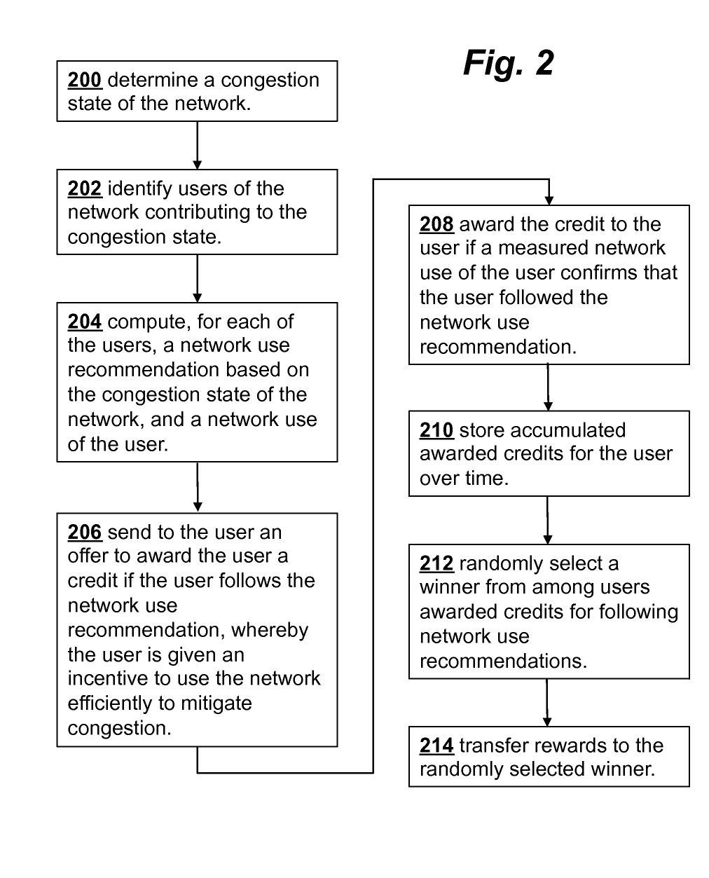

An outline of the main steps of a preferred embodiment of the invention implemented by a server is shown in the flow chart of FIG. 2. The server may be a single computer or a network of distributed computers communicating with each other over a computer network to perform the operations in a coordinated manner. In step 200 the server determines a congestion state of the network. The congestion state may be a present and/or (predicted) future congestion state of the network, and it may be determined in real-time and/or offline.

The congestion state may be determined from network measurements using sensors, meters, monitors, or other instruments connected to the users and/or to the network infrastructure. The network measurements preferably include data indexed by time and location in the network representing the current use and/or state of the network, e.g., number of users accessing the network at specific locations in the network, type or degree of network use by each of the users, use statistics, and measures of network condition. These network measurements are communicated to the server through data communication channels, which may be wired, wireless, or a combination of the two. For example, FIG. 1 shows channel 114 connecting the server 102 to network infrastructure sensors in network 100. Also shown are channels 116 and 118 connecting the server 102 to users 106 and 108, respectively. The server 102 stores and analyzes this data to determine the congestion state of the network, which may include real-time present and/or predicted future congestion states. This data analysis may include, for example, quantitative measures of congestion or resource demand at different times and at different locations in the network. In addition to using current network measurements, the data analysis may also make use of historical network measurements and historical congestion states stored by the server. The server may also specifically analyze historical network use measurements for each user to produce personalized historical network use information which may be stored at the server.

Returning again to FIG. 2, in step 202 the server identifies users of the network contributing to the congestion state. Such users may be identified as currently contributing to a present congestion state or identified as contributing to a future predicted congestion state. Historical and/or current network congestion states may be combined with historical and/or current user information to identify such users. For example, if current network measurements indicate that a particular user is currently accessing the network at a location where the network is congested, such a user may be identified as contributing to the congestion state. Similarly, if historical network congestion states and historical user network use data indicate that a user is likely to access the network at a future time and location where the network is likely to be congested, then the user may be identified as contributing to the (future) congestion state.

In step 204, the server computes, for each of the users, a network use recommendation for the user. This recommendation is computed in real time and/or offline based on the current and/or predicted future congestion state of the network and on the current and/or historical network use information for the user. It may also be based on predicted network use for the user. The recommendation may be computed in real time based on current network congestion state and current network use information for the user information, or it maybe computed offline based on predicted network congestion state and predicted network use for the user. The network use recommendation may be a recommendation to use the network during a specified time, a recommendation to use the network at a specified network location, or a recommendation to engage in a specified type of use of the network. For example, the recommendation may be to postpone current use of the network until after a specified time when a current congestion state of the network is predicted to end. Alternatively, the recommendation may be to use the network at a future specified time (or during a specified time period) that does not coincide with a predicted peak congested state of the network. The recommendation may alternatively, or in addition, specify an uncongested location or region to access the network at a present or future time. In some embodiments, the recommendations may include specifications to access the network in a particular manner. For example, in the case of a transportation network, the recommendation may include a specific route, the user of a particular mode of transport, the use of public transport, or the use of carpooling. In the case of a wireless communications network, the recommendation may include the use of a lower bandwidth mode, or the use of voice only services. Preferably, in order to improve the likelihood that the user will follow the recommendation, the recommendation is customized or personalized to the user based on the user's historical network use and possibly additional information such as the user's patterns of compliance with past recommendations.

In step 206 the server sends an incentive offer to the user. The offer may be sent in real time, i.e., for recommendations relating to the current or imminent network use of the user, or offline (i.e., days or hours in advance of predicted network use of the user). The incentive offer guarantees to award the user a specified credit if the user follows the network use recommendation computed for the user. This incentive offer thus provides the user with an incentive to use the network efficiently to mitigate congestion. The amount of the credit is preferably calculated such that the amount of credit offered is no more than an amount sufficient to expect that the user will likely follow the recommendation. The calculation of the amount of credit is preferably customized or personalized to the user based on the user's historical network use and possibly additional information such as the user's patterns of compliance with past recommendations.

In step 208 the server awards the credit as indicated in the offer to the user if a measured network use of the user confirms that the user followed the network use recommendation in the offer. For example, suppose that the recommendation specified that 5 credits would be awarded to the user if the user accessed the network after particular time. The server then examines measurements of the user's network access to determine if the recommendation was followed by the user. If so, the user's credit account stored at the server is credited with the 5 credits. In step 210 the server stores accumulated awarded credits for the user over time, so that users may build up credits over a period of days or weeks for later redemption. The server may also send to the users information including cumulative awarded credits earned and historical network use data. Such information may be sent, for example, in the form of text messages, email messages, web pages, or any of various other common means of communicating information. This information may be sent over communication channels such as 116 and 118, as shown in FIG. 1.

In addition to communication of cumulative credits and network use history to the user, the server may also receive from the user over the same or similar channels requests to redeem all or a portion of their accumulated credits. In some embodiments, the server may receive from the users requests to redeem awarded credits for cash rewards. The server responds to these requests by awarding the cash rewards to the users and deducting the appropriate number of credits from the user's cumulative credit total stored on the server. For example, if each credit is accorded a value of $0.25, then a user who has accumulated a total of 100 credits over a period of time could redeem them all for $25 in cash. In preferred embodiments, however, the users are provided with the opportunity to redeem their accumulated credits in a raffle, lottery, or other game of chance in which the user has a random chance of being selected as a winner of a reward. For example, each credit could be redeemed for a 1/10 chance to win $10, or a 1/100 chance to win $100. As a result, a user with just 1 accumulated credit has a chance to win $100. This type of incentive is much more effective at motivating many people to follow the network use recommendation.

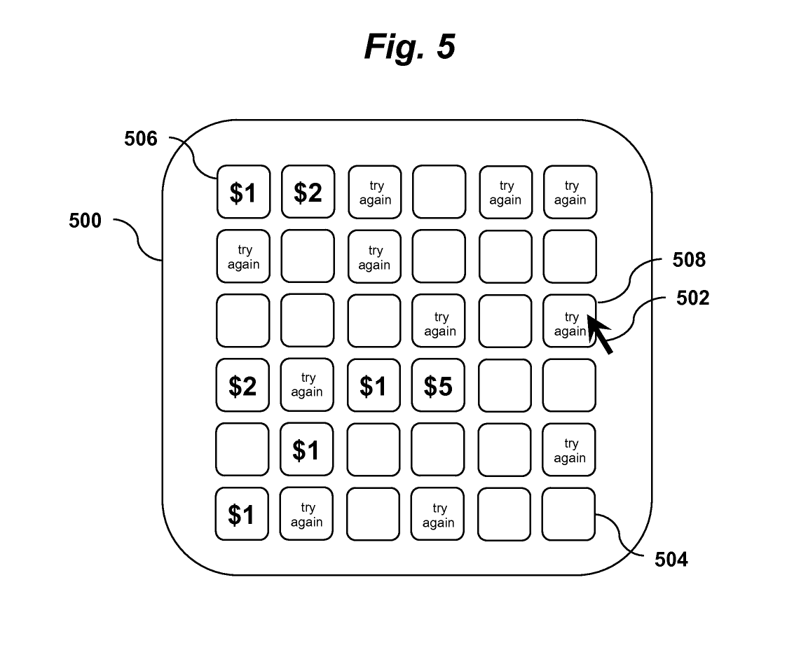

In step 212 of FIG. 2, the server implements a raffle, lottery, or other game of chance in which the server randomly selects a winner from among users awarded credits for following network use recommendations. If a user is a winner, the reward (whether cash or other prize) is transferred in step 214 to the randomly selected winner, e.g., in the form of a funds transfer, coupon, or other token of value. There are various implementations of such an incentive scheme involving a game of chance. In one implementation, after the server receives from a user a request to redeem awarded credits for entry in a game of chance, the server immediately and randomly determines whether the user is a winner in response to the request. For example, FIG. 5 illustrates a user interface 500 generated by the server for display to a user in a web portal. The interface 500 includes a grid of tiles such as tiles 504, 506. Using a pointer 502, the user may select (e.g., by clicking) one of the tiles. When a user selects a tile, the server redeems a predetermined number of the user's accumulated credits. Upon clicking, the tile reveals either a reward prize (in which case the user has been randomly selected as a winner of the prize) or not. For example, tile 506 shows a $1 reward prize, while tile 508 shows no reward prize. Tile 504 remains unclicked. This type of game may be implemented as a single player or multiplayer game.

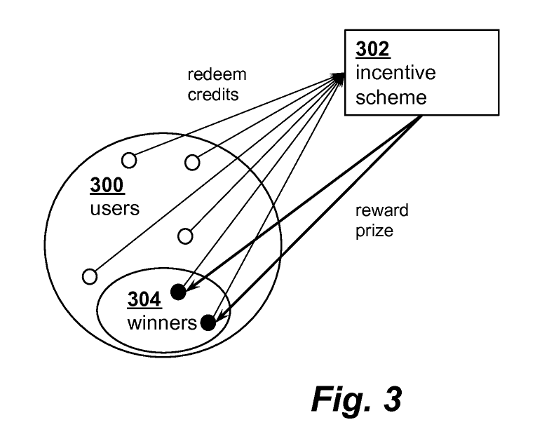

In another implementation, the raffle or lottery is held periodically (e.g., once a week), where the total value of the winner awards is determined by the total accumulated points being redeemed in that period. In some embodiments, multiple winners are selected randomly from among users awarded credits for following network use recommendations, as illustrated in FIG. 3 where all users 100 redeem their accumulated credits using incentive scheme 302 which randomly selects winners 304 from among all the users 300.

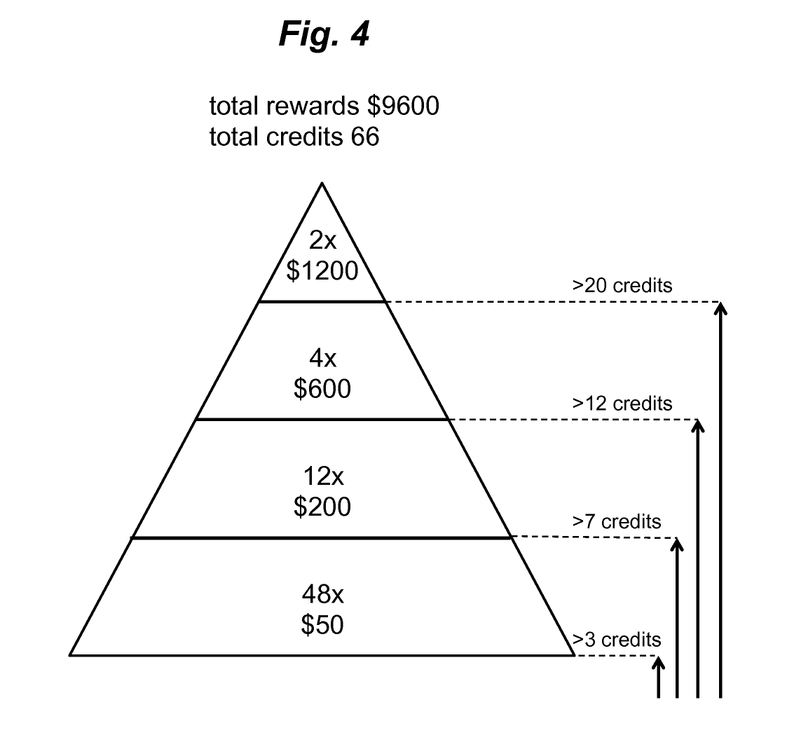

Preferably, the raffle or lottery has a pyramid style structure, as shown in FIG. 4, such that a user who has accumulated more credits has a greater chance of being selected a winner than a user who has accumulated fewer credits. Moreover, a user awarded more credits may be given a greater chance of being selected for a larger reward than a user awarded fewer credits. For example, FIG. 4, shows a pyramid structure having multiple levels where higher levels have larger minimum credit eligibility requirements, fewer winners, and larger rewards than lower levels. Specifically, a user with 20 credits or more is eligible to be one of the 2 winners of the top level prize of $1200, a user with 12 credits or more is eligible to be one of the 4 winners of the second level prize of $600, a user with 7 credits is eligible to be one of the 12 winners of the third level prize of $200, and a user with 3 credits or more is eligible to be one of the 48 winners of the fourth level prize of $50. This type of scheme can be implemented using games such as that shown in FIG. 5, where a different grid is generated and displayed to users having different accumulated credit levels. The credits redeemed for clicking a tile, the total number of rewards in the grid, and sizes of the rewards in the grid would differ for each such grid to reflect the particular level.

The multiple levels of this scheme provide occasional winnings of smaller amounts even to users with low accumulated credits, motivating them to continue earning credits. At the same time, the scheme provides motivation for users at various credit levels to earn more credits in order to be eligible for the larger prizes at higher levels.

The techniques of the present invention may be applied to various different types of capacity-constrained networks that experience congestion at certain times and places in the network. For example, in one application domain, the methods of the present invention may be implemented by a server to mitigate vehicle traffic congestion in a public transportation network, such as a system of roadways and railways in a metropolitan area. There are various possible instantiations of the methods.

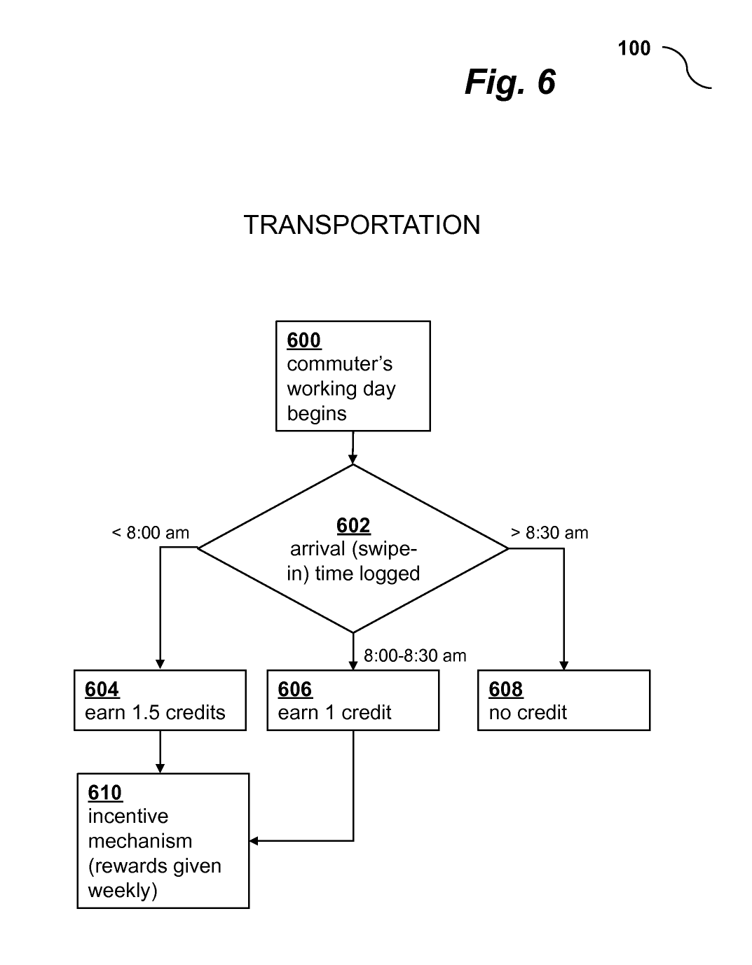

For example, in one embodiment, commuters in a particular metropolitan area are awarded credits for following a recommendation to travel to work before a specified time when the peak morning congestion typically begins. FIG. 6 is a flow chart illustrating the process. The commuter who has elected to participate in the program begins the work day at step 600. Based on historical network measurements, the server determines a typical peak period for the network, which may be customized to each user. For example, the server may determine a typical daily congestion period of the network by estimating a congestion state based on historical network congestion data, which may include historical user trip time data or other measurements. As a participant, the commuter is provided with a standing offer to receive credits in exchange for arriving at work before a specified time. Alternatively, or in addition, the user may be sent offers each morning with recommendations based on current network congestion conditions. The time the commuter arrives is determined in step 602, and may be performed by various means, for example, by a “swipe-in” time at the workplace or other location-based technology capable of providing a timestamp. The user arrival information is then communicated to the server, and credits awarded based on the information which indicates whether the user followed the recommendation or not. In this particular example, the user is awarded 1.5 credits in step 604 if the user arrives at work before 8:00 am. The user is awarded 1 credit in step 606 if the user arrives between 8:00 am and 8:30 am. The user is not awarded any credit in step 608 if the user arrives after 8:30 am. If the user is awarded credits, the credits are accumulated by the server in step 610 and an incentive mechanism can be implemented to allow the users to redeem accumulated credits in various possible ways, as described earlier. It is understood that this scheme may also be used to provide credits for arriving at work significantly later than the morning peak congestion, for departing from work significantly before the evening peak congestion, and/or for departing from work significantly after the evening peak congestion. The commuters may also be awarded credits for using a public transportation system for commuting, irrespective of arrival time. Public transportation use by particular commuters may be logged by the use of electronic tickets at entry and exit points of the public transportation system, and this information may be communicated from the transit system to the server to award the participating users with credits for use of the public transit system in accordance with the recommendation. For example, users may be awarded credits per kilometer traveled using the public transit system during peak commute periods.

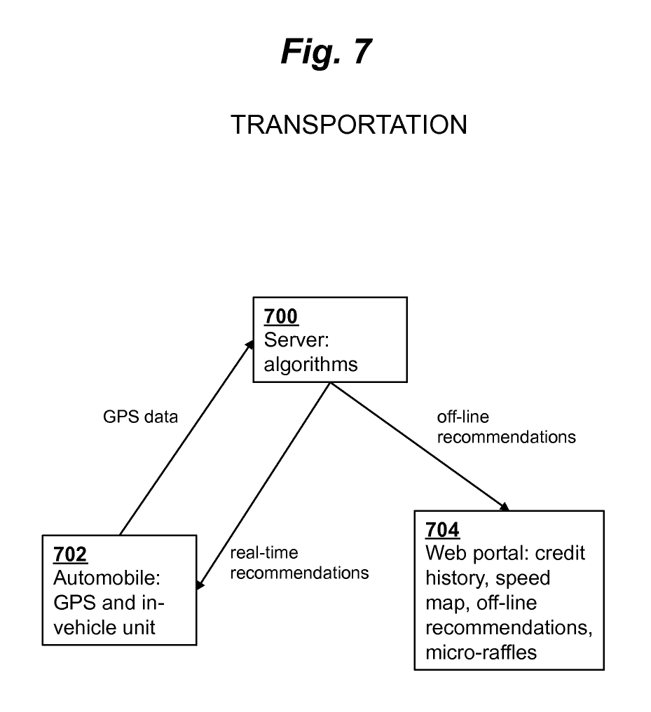

Another embodiment of the invention as applied to a public transportation network is illustrated in FIG. 7 which is a schematic diagram of a system including a server 700, a network user 702, and computer-implemented user interface 704. Each participating user, such as user 702, is equipped with an in-vehicle GPS and communications device for sending current vehicle position data to the server 700 and receiving from the server real-time recommendations while the user is in the vehicle. The server 700 may determine a congestion state of the network by estimating a congestion state based on historical network congestion data and also real-time network congestion data measurements such as real-time GPS location data (“traces”) sent to server from participating users during their vehicle use. This congestion state computed by the server using data mining techniques that may include, for example, collectively mining GPS traces and individually mining user-specific GPS traces. The analysis may produce results such as a mobility heat map, bottle-necks, and traffic jams. This information is then used by the server 700 to identify the users likely to contribute to congestion, compute network use recommendations, and send the users offers for credit awards if they follow the recommendations. Preferably, the recommendations are computed in real-time based on current network congestion state information. The recommendations are preferably also customized or personalized to each user based on both the user's historical network use and the user's current network use, e.g., current location. The real-time recommendations are sent from the server 700 to the user's in-vehicle unit 702 where the user can choose to follow the recommendation or not. GPS data from the in-vehicle unit 702 is sent to the server 700 and used to determine whether the user followed the recommendation or not, and credits are awarded to the user or not.

The server 700 may also predict future network congestion states and the user's predicted network use and send the user offline recommendations in advance of expected network use. The user can access a personalized web portal 704 which displays such offline recommendations and offers for upcoming trips the user may take. The portal 704 also displays to the user historical network use data such as, for example, date and time of travel, route taken, credits earned, and perhaps other details and statistics such as trip duration, travel speed, and trip distance. The portal 704 also provides a user interface for the user to redeem cumulative credits for cash or entry in a game of chance such as a micro-raffle.

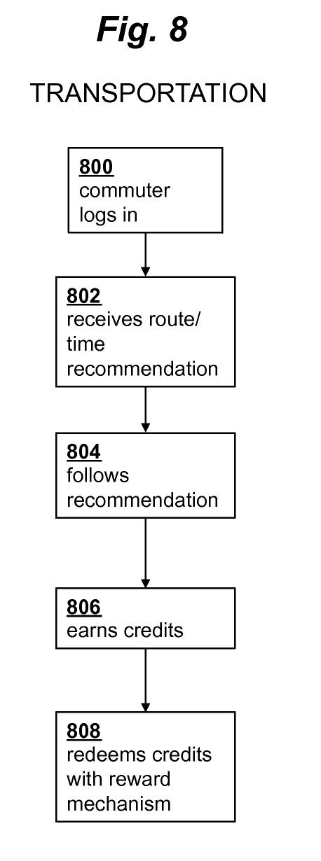

FIG. 8 is a flowchart illustrating the offline recommendation process. In step 800 the commuter logs into the web portal which is generated by the server and remotely displayed to the user on a user computer device. In step 802 the user receives route/time recommendation with an offer to follow the recommendation (e.g., travel by a specific route, and/or starting at a specific time) in exchange for a specified number of credits. In step 804 the user follows the recommendation, e.g., by traveling a particular route, travelling during given time period, or travelling by a specified means. In step 806 the server awards credits to the user, provided network measurements or other information provided to the server confirms that the user followed the recommendation. In step 808 the server provides a web portal with user interface to the user, allowing the user to view credits and network usage statistics, and redeem accumulated credits using a reward mechanism.

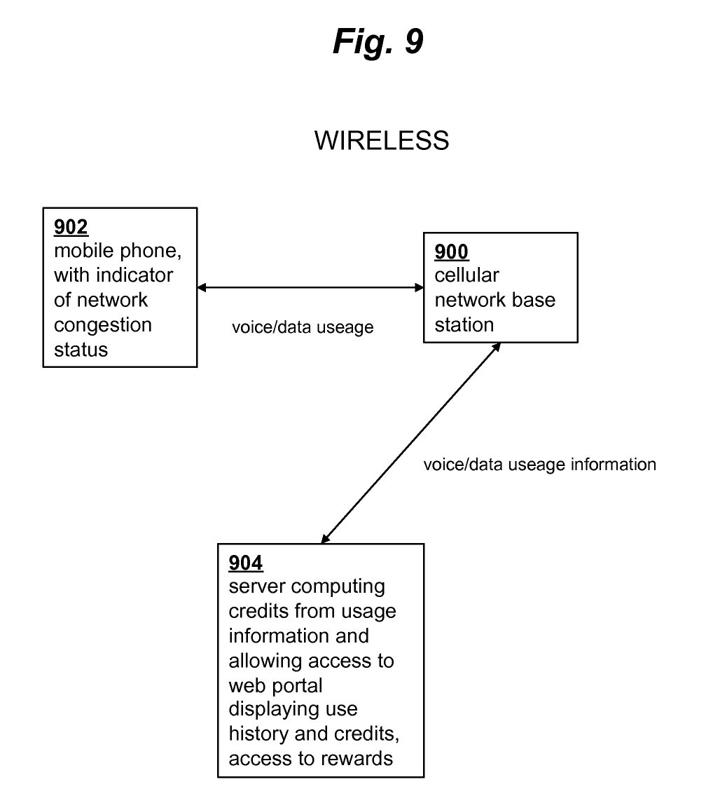

The techniques of the present invention may also be applied to mitigate congestion in wireless communication networks that experience congestion at certain times and places in the network. For example, FIG. 9 is a schematic diagram of a system including a cellular base station 900 providing one access point to a cell of a wireless communication network that is accessible to many users. User 902, for example, is shown using the network in data and/or voice mode through wireless communication with base station 900, which serves one cell of the network. Base station 900 is connected via a data communication link to server 904. The base station 900 sends to the server 904 voice and/or data usage information for user 902 and any other users connected to the base station. This information may pass through intermediate network infrastructure systems between base station 900 and server 904. In addition, server 904 may receive similar information from additional base stations in the network. Using this network use information from the base stations, the server may determine a congestion state of the wireless network, e.g., a current communication load of a particular cellular base station or network data hub. Users of the network contributing to the congestion state may be identified by identifying cellular handsets connected to the network through a congested base station. The server may also identify users contributing to network congestion by identifying users who are likely to access the network during a predicted congestion state. Such predictions may be based upon historical network use data. For example, the network may experience excessive text messaging load during the minutes just before and after midnight of New Year's Eve. In anticipation of predicted network congestion states, or during a current network congestion state, the server may send the user an offer to award the user a credit if the user follows the network use recommendation. Such recommendation may include sending the user an offer to award the user a credit for using the network during a specified time (e.g., at an earlier or later time) or using an alternative mode of access. For example, the recommendation may include sending a text message between 10:00 pm and 11:30 pm on New Year's Eve or between 12:30 am and 2:00 am on New Year's Day. In another example, the technique may include sending a signal causing a display of the user's wireless mobile device to indicate that the base station cell to which the device is currently connected is congested (e.g., a red indicator), and the server may send the user an offer to award the user a credit for using the network later, when the base station is in a non-congested state, or moving to a different uncongested base station cell, or using the base station in a voice-only mode or low bandwidth mode. The server 904 receives from the base station 900 information about the user's network usage that is used to determine whether the user followed the recommendation. Note that, in general, the user may be provided with several alternative recommendations which may have the same or different number of associated credit awards. For example, a user may be offered more credits for following a recommendation expected to have a larger congestion mitigation effect than credits awarded for following another recommendation expected to have a smaller mitigating effect. As in other embodiments, the server 904 also generates a web portal displaying to the user network use history, credit award history, accumulated credit total, and selections for redeeming award credits, e.g., by redeeming credits for entry in a raffle, lottery, or other game of chance.

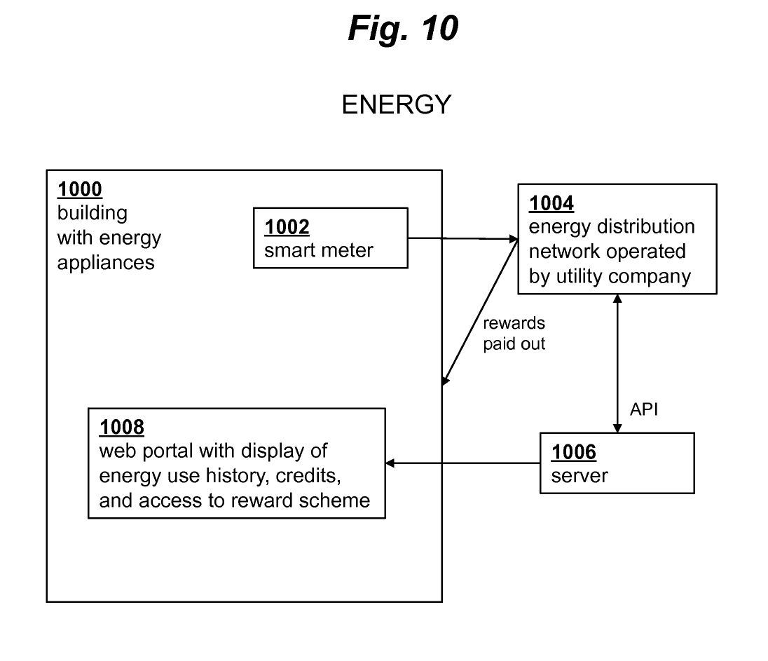

Another type of capacity-constrained network that may experience congestion at certain times and places are energy distribution networks. The techniques of the present invention may thus be applied to mitigate congestion in such energy distribution networks whose users include utility customers. By appropriately incentivizing such customers, excessive energy demand in the energy distribution network may be mitigated. An example of a system to implement an embodiment of the invention in this context is shown in FIG. 10. A building 1000 containing energy appliances such as an HVAC system uses an energy distribution network 1004 that distributes energy, e.g., through an electrical power grid, natural gas pipelines, or other means. Network 1004 also is used by many other utility customers such as building 1000. The utility 1004 obtains network energy use information about user 1000 from conventional meter readings as well as smart meter 1002 which provides real time energy use information. This network use information is forwarded with network congestion state information from the network 1004 to the server 1006 for storage and analysis. This information is then used by the server 1006 to identify the users of the network contributing to the congestion state, e.g., users having a current energy user higher than a predetermined benchmark for the present time of day and season. Users may then be offered credits by the server 1006 for following a recommendation to decrease their energy consumption during a specified time (e.g., during peak energy use periods of the network). Such offers may be communicated to the user through a web portal 1008 customized to the user 1000. The portal may also display energy use history, credits earned, and provide access to credit reward schemes such as described in relation to other embodiments. Rewards as determined by the server may be paid to the winning customers directly from the utility company 1004 or through other channels. The server may analyze user energy consumption patterns and redemption behavior in order to customize credit award amounts and recommendations contained in the offers made to particular users in order to increase likelihood that the user will follow recommendations. As in other embodiments, there may be several different recommendations offered simultaneously with different associated credit awards. For example, during a peak energy period, a user can be offered twice as many credits for following a recommendation to cut energy use by 20% below historical use levels than credits offered for following a recommendation to cut energy use by just 10%.

The principles of the present invention may also have application to other domains. For example, the network may be a health care system and users may be patients or users who are offered award credits for following recommendations that will increase their health or wellness and reduce demand on the health care system. For example, user may be offered credits for following recommendations to engage in activity known to benefit overall health, such as walking for a specified period of time or specified distance. Pedometers or other activity monitors (e.g., a smartphone equipped with an accelerometer) can record user activity to determine compliance with the recommendation. This activity data may then be sent to the server (e.g., automatically over a wireless link using a smartphone application) so that credits may be awarded to the user. As in other embodiments, the server provides users with a user interface for viewing historical activity and for redeeming accumulated credits for participation in raffles, lotteries, or games of chance. Such embodiments may be implemented without the server necessarily determining a congestion state of the network or identifying users contributing to the congestion state. Consequently, the recommendations computed by the server would not necessarily depend on the congestion state of the network or network use of the user. Additionally, the recommendations in such embodiments may be to engage in particular activities beneficial to their health, independent of any direct use of a health care network.

Embodiments of the present invention may also be enhanced by integration with an electronic social networking feature. For example, subject to user permissions and preferences, user data such as credits earned, activity following recommendations, and/or network use may be published to an online social networking system with friend lists and newsfeed features so that communities of users can easily view each other's credits, activities, and network use.

1. A method for mitigating congestion of a network, the method comprising:
determining by a server a congestion state of the network;
identifying by the server users of the network contributing to the congestion state;
computing by the server, for each of the users, a network use recommendation based on the congestion state of the network, and a network use of the user;
sending from the server to the user an offer to award the user a credit if the user follows the network use recommendation, whereby the user is given an incentive to use the network efficiently to mitigate congestion;
awarding by the server the credit to the user if a measured network use of the user confirms that the user followed the network use recommendation;
storing by the server accumulated awarded credits for the user over time;
randomly selecting by the server a winner from among users awarded credits for following network use recommendations;
transferring rewards to the randomly selected winner.

2. The method of claim 1 wherein the congestion state is a present state of the network.

3. The method of claim 1 wherein the congestion state is a future state of the network.

4. The method of claim 1 wherein the computing of the network use recommendation is based additionally on historical congestion states of the network.

5. The method of claim 1 wherein the computing of the network use recommendation is based on historical network use of the user.

6. The method of claim 1 wherein the computing of the network use recommendation is based on current network use of the user.

7. The method of claim 1 wherein the determining, identifying, computing, and sending are performed in real time.

8. The method of claim 1 wherein the network use recommendation is a recommendation to use the network during a specified time.

9. The method of claim 1 wherein the network use recommendation is a recommendation to use the network at a specified network location.

10. The method of claim 1 wherein the network use recommendation is a recommendation to engage in a specified type of use of the network. (e.g., mode of transport, public transport, carpooling, lower bandwidth mode, voice only)

11. The method of claim 1 further comprising sending to the users of the network information including cumulative awarded credits earned and historical network use data.

12. The method of claim 1 further comprising receiving from the users of the network requests to redeem awarded credits for entry in a game of chance.

13. The method of claim 1 wherein the randomly selecting by the server is performed immediately in response to a request by one of the users.

14. The method of claim 1 wherein the randomly selecting and transferring rewards are performed periodically.

15. The method of claim 1 wherein the randomly selecting by the server is selects multiple winners from among users awarded credits for following network use recommendations.

16. The method of claim 1 wherein the randomly selecting by the server a winner is performed such that a user awarded more credits has a greater chance of being selected than a user awarded fewer credits.

17. The method of claim 1 wherein the randomly selecting by the server a winner is performed such that a user awarded more credits has a greater chance of being selected for a larger reward than a user awarded fewer credits.

18. The method of claim 1 further comprising receiving from the users of the network requests to redeem awarded credits for cash rewards; and awarding the cash rewards to the users in response to the requests.

19. The method of claim 1 wherein the network is a public transportation network and the congestion is vehicle traffic congestion in the public transportation network.

20. The method of claim 1 wherein determining by a server a congestion state of the network comprises estimating a congestion state based on historical network congestion data. (e.g., trip time data)

21. The method of claim 1 wherein determining by a server a congestion state of the network comprises estimating a congestion state based on real-time network congestion data measurements. (e.g., real-time GPS traces sent to server)

22. The method of claim 1 wherein the a congestion state of the network comprises mobility heat map, bottle-necks, and traffic jams.

23. The method of claim 1 wherein identifying by the server users of the network contributing to the congestion state comprises predicting user network use based on historical user network use data.

24. The method of claim 1 wherein identifying by the server users of the network contributing to the congestion state comprises predicting user network use based on real-time user network use data. (e.g., GPS traces)

25. The method of claim 1 further comprising measuring GPS tracks of the user to determine the measured network use of the user.

26. The method of claim 1 wherein the network use recommendation is a recommendation to follow a specified route at a specified time.

27. The method of claim 1 wherein the network is a wireless communications network and the congestion is wireless traffic congestion in the wireless communications network.

28. The method of claim 1 wherein determining by a server a congestion state of the network comprises measuring a current communication load of a cellular base station.

29. The method of claim 1 wherein identifying by the server users of the network contributing to the congestion state comprises identifying cellular handsets connected to the network through a congested base station.

30. The method of claim 1 wherein identifying by the server users of the network contributing to the congestion state comprises identifying users who are likely to access the network during a predicted congestion state.

31. The method of claim 1 wherein sending to the user an offer to award the user a credit if the user follows the network use recommendation comprises sending the user an offer to award the user a credit for using the network during a specified time.

32. The method of claim 1 wherein sending to the user an offer to award the user a credit if the user follows the network use recommendation comprises displaying to the user an indication that a base station cell is currently congested and an offer to award the user a credit for using the network from a non-congested base station cell.

33. The method of claim 1 wherein the network is an energy distribution network and the congestion is excessive energy demand in the energy distribution network.

34. The method of claim 1 wherein identifying by the server users of the network contributing to the congestion state comprises identifying utility customer smart energy meter readings higher than a predetermined benchmark.

35. The method of claim 1 wherein the network is a health care network and the congestion is excessive demand on the health care network.

36. A method for incentivizing wellness comprising:
implementing by a server an online social network;
identifying by the server users of the social network who are enrolled in a wellness incentive program;
computing by the server, for each of the users, a recommendation to engage in activity that will increase wellness and health;
sending from the server to the user an offer to award the user a credit if the user follows the recommendation to engage in activity that will increase wellness and health;
awarding by the server the credit to the user if a measured activity of the user confirms that the user followed the recommendation to engage in activity that will increase wellness and health;
storing by the server accumulated awarded credits for the user over time;
providing by the server a user interface visible on the social network for viewing accumulated awarded credits and associated historical activity of the user;
randomly selecting by the server a winner from among users awarded credits for following network use recommendations;
transferring rewards to the randomly selected winner.
